(19) United States
(12) Patent Application Publication
(10) Pub. No.: US 2007/0034619 A1
(43) Pub. Date: Feb. 15, 2007

(54) Magnetic Ground Clamp

(76) Inventor: Ian Godfrey Heard, Elanora Heights (AU)

Correspondence Address: SERPENT AND DOVE PTY LTD, UNIT 6-32 CAMPBELL AVENUE, CROMER NSW, 2099, AU

(21) Appl. No.: 11/463,310

(22) Filed: Aug. 9, 2006

Related U.S. Application Data
(60) Provisional application No. 60/706,728, filed on Aug. 10, 2005.

(51) Int. Cl. H01R 4/58

(52) U.S. Cl. 219/136; 439/39

(57) ABSTRACT

A magnetic ground (or earth) clamp in which the current carrying electrode is electrically insulated from the housing to prevent electric arcing between the electrode and the housing or between the housing and the surface to which it is clamped.

### CROSS-REFERENCE TO RELATED APPLICATIONS

The present Utility patent application claims priority benefit of the U.S. Provisional Application for patent No. 60/706,728 filed on Aug. 10, 2005 under 35 U.S.C 119(e)

### FIELD OF THE INVENTION

The invention pertains to permanent magnetic clamping devices and specifically to permanent magnetic clamping devices used to magnetically secure an electrical ground (or earth) connection to workpieces during electric welding.

### BACKGROUND OF THE INVENTION

Typically magnetic grounding or earthing clamps employ a copper, brass or other suitably conductive metal electrode passing through a magnetic clamping device. Typically, the magnetic clamping device comprises a ferromagnetic (steel) cup, housing a ferrite or rare earth magnetizing element, concentrating magnetic flux across a small air-gap to provide magnetic clamping strength. A spring-loaded electrode passes through this cup and is firmly retained against a ferromagnetic workpiece, under pressure of the spring, so that the electrical current flows through the electrode and into the workpiece. A limitation of such design is the propensity of the electrode to be in contact or partial or intermittent contact with the perimeter of the hole in the magnetic clamp through which it passes. Partial and intermittent contact is a particular problem because when this occurs, electrical arcing occurs between the electrode and the magnet housing, burning the edges of the hole or depositing weld-spatter around the perimeter of the hole. This in turn, can prevent ease of movement of the electrode in the hole and such ease of movement of the spring-loaded electrode, up and down is necessary for effective operation and contact pressure between the electrode and the workpiece. A further problem is created by electrical current flowing through the housing of the clamp as follows; where the clamping edges are not in clean contact with the workpiece because of grit or dirt, arcing can also occur at this point, damaging the clamping edges of the clamp, defacing the surface of the workpiece or, in a worst case, welding the clamp to the workpiece. The present invention addresses these deficiencies.

### DETAILED DESCRIPTION OF THE INVENTION

The present invention is illustrated by way of example, and not by way of limitation in the figures of the accompanying drawings and in which like reference numerals refer to similar elements and in which:

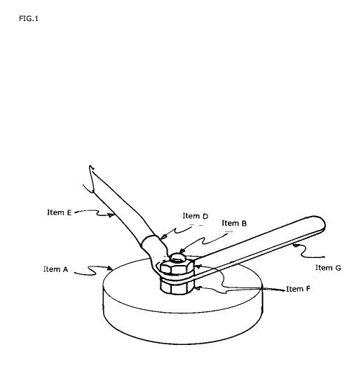

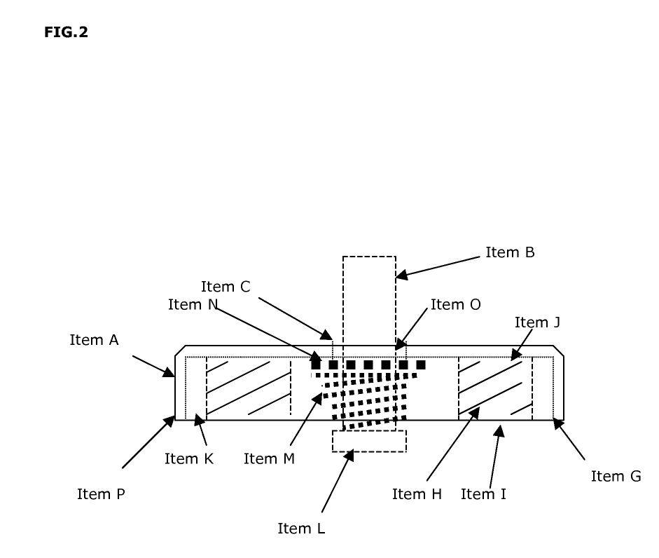

FIG. 1 illustrates but by no means limits with respect to shape or type a common type and shape of magnetic ground (or earth) clamp. A ferrite, neodymium or other magnetizing element (shown as Item H in FIG. 2) is housed within a ferromagnetic (typically steel) cup or housing, Item A. Item B is a copper, brass or other conductive metal electrode which passes through a hole (not seen in this view) in the cup or housing. Item D is a typical cable lug at the end of cable Item E (Items D and E shown only for understanding). Frequently nuts, Items F secure the cable and retain a handle, Item G which is used to assist removal of the magnetic clamp from a workpiece.

FIG. 2 is a section through the centre of the device to illustrate component parts. As for FIG. 1, Item A is the ferromagnetic cup or housing, preferably made of soft iron or steel and Item B is the conductive metal, preferably copper or brass, electrode, passing through hole, Item C. The cup or housing, Item A contains a magnetizing element, Item H, of ferrite, neodymium, alnico or other magnetized material having one face, Item I, a south magnetic pole and the opposite face, Item J, a north magnetic pole. The polarity that is in contact with the ferromagnetic cup, Item A, is conducted to the edge of the cup so that a north-south magnetic air-gap is created, Item K providing clamping force when placed on a ferromagnetic workpiece. Electrode Item B is preferably provided with a flat electrical contact surface, Item L at its end and passes through the hole, Item C. Electrode Item B is preferably spring-loaded with a spiral spring Item M and at rest, the electrode sits below the clamping surface of the clamp. When the clamp is placed on a ferromagnetic surface, spring Item M provides downward pressure on the electrode so that good electrical contact is achieved between the electrode and a surface. Typically and preferably also, an electrically insulating washer, Item N is placed between the inner face of the cup or housing and the upper end of the spring. In this drawing the upper end of the electrode is shown without nuts or cable attachments for clarity. Items O and P show typical points at which electric arcing occurs when the electric welding current takes a preferential path via the housing Item A to a clamped workpiece.

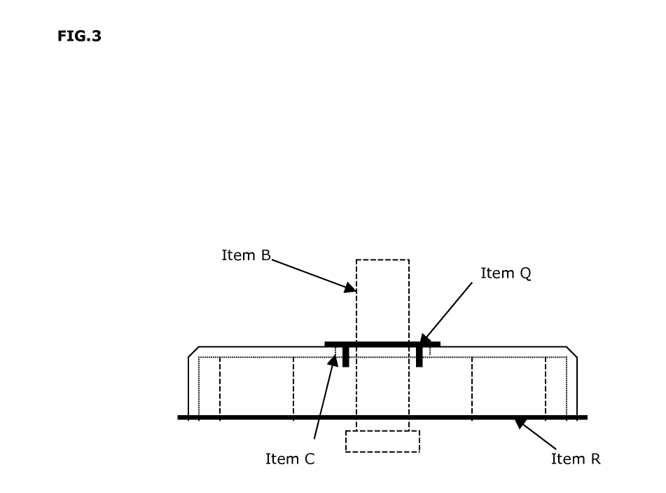

FIG. 3 is the same section as FIG. 2 with spring, Item M not shown in order to enhance clarity. Insert, Item Q is a washer of electrically insulating material having a clearance hole at its centre to allow electrode, Item B to pass through it and also forming part of it, a cylindrical protrusion of size, depth and wall thickness to fit between the electrode and the perimeter of the hole item C in the cup A thus preventing contact between the electrode or the nuts attached to the electrode, and the cup. The washer Item Q preferably inserts from the top of hole C as shown but could also be inserted from below if washer Item N is alternatively placed on the outside of the housing to prevent electrical contact between the nuts and the magnet housing. In alternative embodiments Item Q may comprise two halves inserted from top and bottom of hole C. In a further alternative embodiment an insulating washer, Item R, having a clearance hole at its centre to allow the electrode Item B to move up and down, covers the entire clamping surface of the device. A disadvantage of this alternative embodiment is that an additional air-gap is created by the thickness of the washer, between the clamping edges and the clamped surface, thus decreasing clamping pressure.

What is claimed is:

1. A magnetic ground (or grounding) clamp wherein the current conducting electrode passes through the magnetic clamping element, having a cylindrical sleeve of electrical insulating material surrounding that portion of the electrode that passes through the metallic housing.

2. A magnetic ground (or grounding) clamp wherein the current conducting electrode passes through the magnetic clamping element, having a cylindrical sleeve of electrical insulating material surrounding that portion of the electrode that passes through the metallic housing, said cylindrical sleeve having at one end an integral flat portion perpendicular to the cylinder and of sufficient outer perimeter to provide electrical insulation between any fitments attached to the electrode and the magnet housing.

3. A magnetic ground (or grounding) clamp wherein the current conducting electrode passes through the magnetic clamping element, having more than one cylindrical sleeve of electrical insulating material surrounding that portion of the electrode that passes through the metallic housing, said sleeves having integral flat portions perpendicular to the cylinders and of sufficient outer perimeter to provide electrical insulation between any fitments attached to the electrode and the magnet housing.

4. A magnetic ground (or grounding) clamp wherein the current conducting electrode passes through the magnetic clamping element, having a cylindrical sleeve of electrical insulating material surrounding that portion of the electrode that passes through the metallic housing, said cylindrical sleeve having at one end an integral flat portion perpendicular to the cylinder and of sufficient outer perimeter to provide electrical insulation between any fitments attached to the electrode and the magnet housing.

5. A magnetic ground (or grounding) as in claims 1 to 4 above and having in addition an electrically insulating disc or plate through which the electrode passes attached to the entire clamping surface of the clamp so as to provide electrical insulation between the clamp and any surface upon which it is placed.

6. A magnetic ground (or grounding) having an electrically insulating disc or plate through which the electrode passes attached to the entire clamping surface of the clamp so as to provide electrical insulation between the clamp and any surface upon which it is placed.
